(19) United States
(12) Patent Application Publication
(10) Pub. No.: US 2002/0083103 A1
(43) Pub. Date: Jun. 27, 2002

(54) Machine editing system incorporating dynamic rules database

(76) Inventors: Chanin M. Ballance, Portland, OR (US); Francis A. Halpin, Portland, OR (US); James Dirksen, Portland, OR (US); Dieter Waiblinger, Lake Oswego, OR (US)

Correspondence Address: STOEL RIVES LLP, 900 SW FIFTH AVENUE, SUITE 2600, PORTLAND, OR, 97204, US

(21) Appl. No.: 09/970,151

(22) Filed: Oct. 2, 2001

Related U.S. Application Data
(60) Provisional application No. 60/237,226, filed on Oct. 2, 2000.

(51) Int. Cl. G06F 15/00

(52) U.S. Cl. 707/536

(57) ABSTRACT

Documents translated from one language to another, especially machine-translated documents, typically require editing to better reflect the nuances of language content and meaning; and especially the use of nomenclature that is culture and or industry specific, or even company specific. A dynamic database of editing rules helps to automate this editing of already-translated documents. An initial set of editing rules is deployed in the database and used to edit machine-translated documents. Manual changes subsequently made to the machine-edited documents are recorded and that data is used to form updates or additions to the initial editing rules. Over time, the rules database improves so that machine editing is more effective and, conversely, the manual editing burden and corresponding cost is reduced.

### RELATED APPLICATION DATA

This application is a continuation of U.S. Provisional Application No. 60/237,226 filed Oct. 2, 2000 and incorporated herein by this reference.

### TECHNICAL FIELD

The present invention relates generally to globalization, localization, machine translation, post-machine translation and editing. More specifically, it pertains to a new field called Machine Editing (ME), and includes evolving a dynamic database of editing rules especially useful to support editing documents that were initially produced by translation from one spoken language to another.

### BACKGROUND OF THE INVENTION

Software products are known having some capability to translate documents from one language to another. In general, these automated translation processes have an error rate of over 30%. This is attributable to several factors; the pure complexity of language and our ability to identify and program systems to make intelligent decision about translation; the nuances that exist in language content and meaning; and the ever changing and evolving nature of language, including the use of specific cultural and industry terminology that may not be known or accounted for in the automated translation system. Even current events can affect whether particular phrases are appropriate in a given context.

In practice, machine-translated documents require considerable manual (human) editing to make them into high quality products that convey the original author's intended meaning in a manner that is consistent with the target audience's language and culture, including nuances of phraseology.

What is needed is a way to reduce the extent of human editing and review necessary to produce high-quality documents that were translated from one language to another, and thereby reduce the cost of such documents.

The need remains as well to capture editing knowledge—accumulated knowledge resulting from human editing of many different documents by many different editors—and preserve that knowledge in a re-usable form to improve the quality of both machine translating and machine editing.

### SUMMARY OF THE INVENTION

One aspect of the present invention comprises an automated editing system that will intelligently edit a company's or industry's documents based on a Dynamic Editing Knowledge Base (“DEK”). The Dynamic Editing Knowledge Base in a presently preferred embodiment contains company and industry specific editing rules that reflect corrections that were made during manual editing activities. In short, the system is able to learn from human editing activities and intelligently apply the edits to future jobs without the direct aid of a human.

According to another aspect of the invention, a comparison object compares a pre-edit state document to a post-edit state document, and records the differences in a Harvest database. The Harvest database collects information about these differences, and uses them to formulate possible new or revised rules to augment or refine the Dynamic Editing Knowledge Base.

A process for machine editing according to the present invention calls for first establishing an initial editing knowledge base, which may be quite small at the outset. A machine-editing software object is linked to the editing knowledge base so that it can employ those rules for machine-editing a document. The document is received from a remote customer or user in a machine-readable, “pre-machine edit state.” The process proceeds to machine-editing the received document using the machine-editing software object so as to produce a “post-machine edit state” of the document. The next step is manually editing the post-machine edit state of the document, including making a change if appropriate to the post-machine edit state of the document. Such changes to the post-machine edit state are recorded.

These receiving, machine-editing, manually editing and recording steps are repeated over multiple documents. The documents may have been edited by different human editors. The accumulated data is analyzed so as to detect a pattern of such changes, and finally the process calls for refining the editing knowledge base responsive to the detected pattern so as to improve the quality of subsequent machine editing that uses the knowledge base to automatically edit a document.

This process can be used as well for editing documents that were not previously translated from one language to another. It can simply be used to improve the quality of a document, and to evolve the knowledge base.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 is a conceptual diagram of an editing process according to the present invention incorporating a dynamic editing knowledge-base or Dynamic Editing Knowledge Base.

FIG. 2 is a simplified block diagram of a presently preferred software architecture for implementing a system of the type illustrated in FIG. 1.

### DETAILED DESCRIPTION OF PREFERRED EMBODIMENT

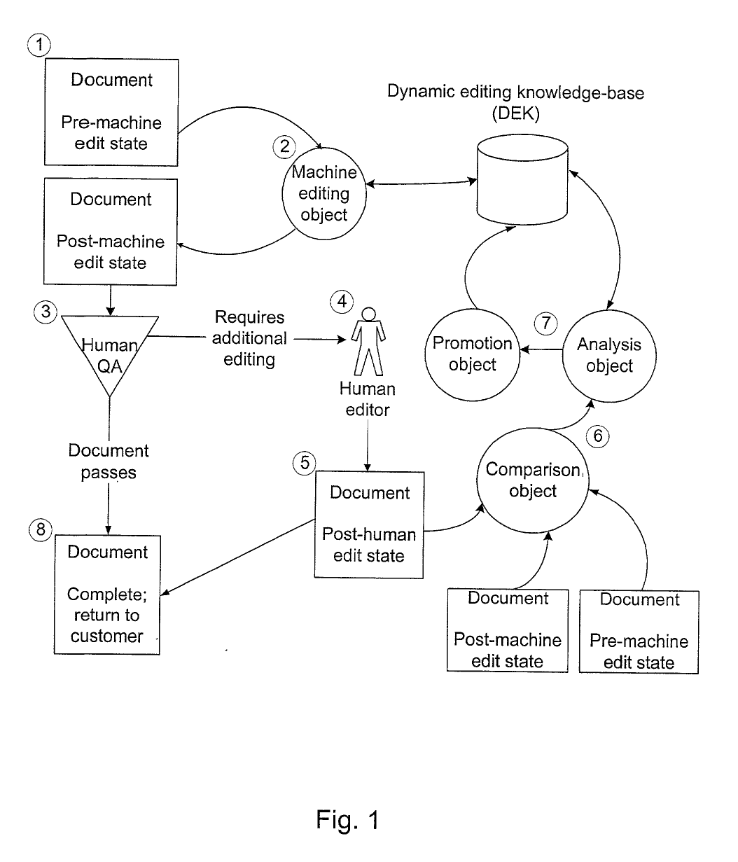

FIG. 1 is a conceptual diagram of a process for editing a document both by machine and manually, and capturing information from that process so as to evolve a set of rules to improve the quality of subsequent machine editing jobs. FIG. 1 illustrates the following process steps:

1. A document is submitted to the system, in digital form, for editing. This is a Pre-Machine Edit State document.

2. A Machine Editing (ME) Object, preferably using a windowing method, scans the document and appropriate edits are applied based on known corrections in a Dynamic Editing Knowledge Base (DEK)

3. A human editor or QA determines if the editing is appropriate and complete. If the ME Object has appropriately and adequately edited the document it is returned to the author, step 8. If the document requires additional editing it is routed to a human, step 4.

4. The human edits the document manually, making note of ME mistakes, etc.

5. The Human Edited document is ready to be returned to the author, step 8, and it is submitted back to the system for comparison, step 6.

6. The system compares the Pre-Machine document (from step 1) to the Post-Machine document (from step 2) and most importantly to the Post-Human edited document (from step 5). The Analysis Object compares the edits to edit corrections that may or may not exist in Dynamic Editing Knowledge Base. The results are passed to the Promotion Object, step 7.

7. The Promotion Object may request human interaction before promoting additional editing rules to the Dynamic Editing Knowledge Base or it may update the DEK automatically if the new editing corrections meet certain specifications.

Once the new editing rules have been promoted to the Dynamic Editing Knowledge Base, the next time a similar document is submitted to the system for editing the ME Object will be able to make more corrections and better corrections because of the new and improved information in DEK.

The Dynamic Editing Knowledge Base associates individual rules with specific customers, i.e., companies, departments and even individual authors. It also associates rules with specific industries or types of documents. In this way, only appropriate rules are applied to each document under review.

In a presently preferred embodiment, the DEK includes metadata associated with each rule, for example, country, profession or industry, language from which the document was translated, language into which the document was translated, native language of the original author, customer or company, division, location, etc.

The rules database further includes experience data for each rule. For example, it tracks how often a rule violation is detected; how often the rule is applied correctly; and, how often the rule is applied incorrectly. By the latter, we mean that a human quality-control person subsequently concluded that the rule as applied resulted in an error, and accordingly the “correction” is overruled. This data is used to calculate a score indicating the effectiveness of the rule. Very effective rules are good candidates for promotion into an automated editing application.

Edit System Components and Architecture

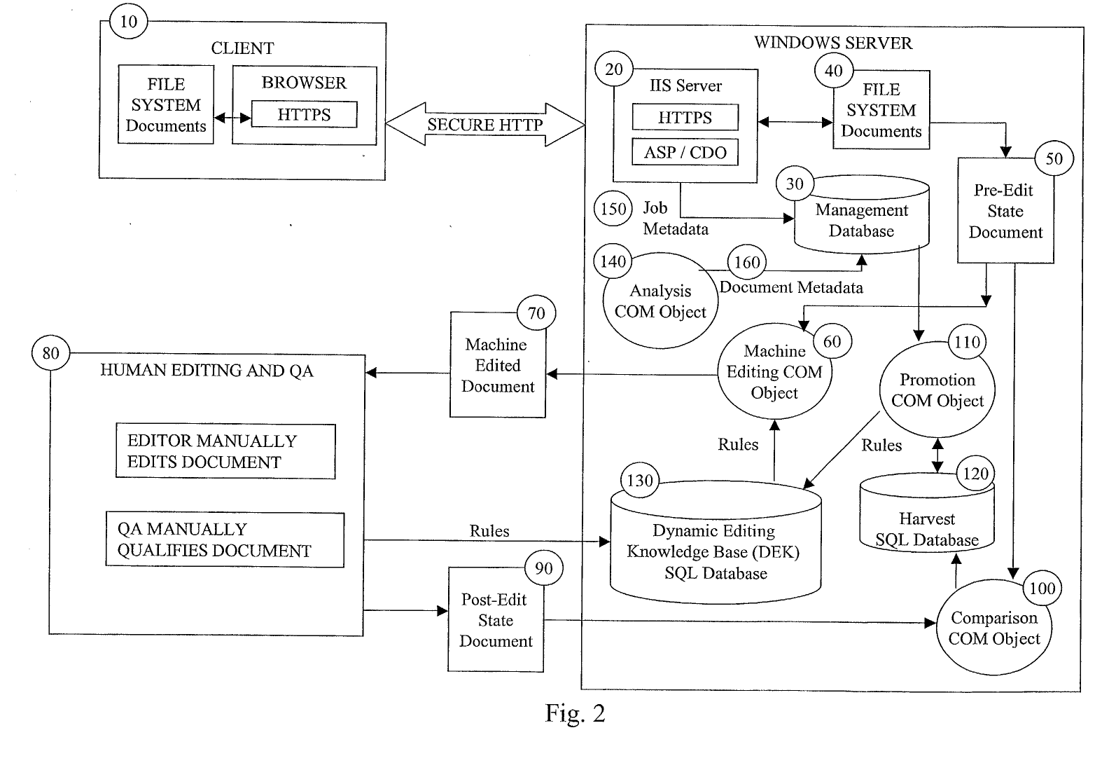

Referring now to FIG. 2, a presently preferred software architecture is shown for implementing the process of FIG. 1. A client machine or process 10 includes a conventional file system for creating and storing a document, and a standard web browser application. Preferably the web browser utilizes a secure hypertext transfer protocol (HTTPS) to submit a selected document, namely a “Pre-Edit State Document” 50 to the editing system 20. The editing system can be deployed on any suitable server type of platform, for example utilizing Microsoft's IIS Server technology. This architecture enables submission (and return) of documents for editing from anywhere Internet access is available. The invention could also be deployed locally, e.g., on a LAN or corporate WAN.

To submit a document, the customer fills out an electronic job submittal form (not shown) which identifies their Job Metadata 150. Job Metadata can include, by way of example and not limitation, the company name, department name, author name, date and time stamp, document industry, and document terminology type (although some of these can be implied by others). One function of this metadata is to ensure that only appropriate editing rules will be applied to this document (job).

A Web server 20 that uses secure hypertext transfer protocol (HTTPS) receives the Pre-Edit State Document 50. It stores the document in an Editing File System 40 and inserts the corresponding Job Metadata 150 from the associated electronic form into a management database 30. SQL or other convenient database query languages can be used in connection with the management database 30. In general, this database stores and updates job metadata, document metadata, and Customer Profile Information (such as company, industry, department, login, et cetera).

Document Metadata is information about a specific document submitted by the customer as part of an editing job. A “document” can be expressed in any file format such as PowerPoint, Word, Excel, Adobe Acrobat, Quark Xpress, HTML, TXT, RTF, etc. The document metadata in addition to the file format generally includes editing metrics such as grammar errors, spelling errors, word count, and page count.

The Editing File System 40 stores Pre-Edit State Document(s) 50, Post-Edit State Document(s) 90 and Machine-Edited Document 70 through the job lifecycle. This is also used as an archive to provide raw sample documents to the Promotion Object 110 for developing new Rules at a later time.

The Pre-Edit State Document 50 is the customer submitted document in raw form. This is made available to a Machine Editing Object 60. The Machine Editing Object takes the Pre-Edit State Document, applies Dynamic Editing Knowledge Base (DEK) 130 rules, and makes the resulting Machine-Edited Document 70 available to Human Editors 80 for editing and quality assurance review. Thus Machine-Edited Document 70 is the output of the Machine-Edited Object 60 used in conjunction with the Pre-Edit State Document 50 by the Human Editors to edit the job.

More specifically, in the Human Editing and QA process 80, qualified Human Editors manually review and (further) edit the Pre-Edit State Document 50 using the Machine-Edited Document 70, thereby producing the Post-Edit State Document 90. Quality Assurance staff then tests and approves the Post-Edit State Document 90, or returns the file to the Editor for further editing. Changes made by the human editors are captured and stored. During this phase of the process, humans (editors) may invent new rules to be considered by submitting them to the Promotion Object 110 described below. To summarize, the Post-Edit State Document 90 has been machine-edited, human-edited, and approved by QA for return to the customer. Delivery is handled by communication between the server 20 and the customer/client 10.

A Comparison Object 100 compares the Pre-Edit State Document 50 to the Post-Edit State Document 90, and stores the “before” and “after” data specifying each change to the document, and stores all of the changes with associated metadata (or pointers to associated metadata) in a Harvest database 120 (e.g., a SQL database). The change data includes indicia as to whether each change was made by machine editing or by the human editors.

Promotion Object 110 harvests potential Rules and reports them to the staff for approval. The staff then adds, modifies, or changes Rules in the DEK 130.

The Promotion Object improves the rules database (DEK) over the course of time as it continually searches for patterns and similarities presented by the changes recently applied by editors and currently stored in the Harvest database. It also searches for patterns and similarities in the Pre-Edit State Documents 50 and the Post-Edit State Documents 90 stored in the document archives. The Promotion Object 110 associates the Job and Document Metadata to the rules that reside in the Harvest database to refine the application of those rules based on Job Metadata such as Industry and requested Editing Service level and on Document Metadata such as document type.

Harvest SQL Database 120 stores differences between the Pre-Edit State Document 50 and the Post-Edit State Document 90. This also contains harvested rules from archived Pre-Edit State Documents 50 and Post-Edit State Documents 90. It may also contain suggested rules entered by Humans and/or the Promotion Object 110.

The Dynamic Editing Knowledge Base 130 contains all active Rules, generated originally by the Human Editors 80 and/or suggested by the Promotion Object 110. The rules database (DEK) associates individual rules with specific customers, i.e., companies, departments and even individual authors. It also associates rules with specific industries or types of documents.

The rules database further includes experience data for each rule. For example, it tracks how often a rule violation is detected; how often the rule is applied correctly; and, how often the rule is applied incorrectly. By the latter, we mean that a human quality-control person subsequently concluded that the rule as applied resulted in an error, and accordingly the “correction” is overruled. This data is used to calculate a score indicating the effectiveness of the rule. Very effective rules are good candidates for promotion into an automated editing application.

In an alternative embodiment, the experience data is accumulated in the Harvest database 120. The Harvest database object includes methods for analyzing comparison data provided by the comparison object 100, and based on the experience data formulating potential new rules.

Analysis Object 140 analyzes Pre-Edit State Document 50 and generates Document Metadata 160 which is stored in the management database 30 as further described below.

Job Metadata refers to information about a specific editing job submitted by a customer. This data includes items such as: industry, company, department, file name, service level (edit, translate, diplomat, machine translate, et cetera).

The management database 30 contains data elements that support an Editing Job lifecycle which include but are not limited to overall Job Metadata 150 such as Customer profiles, Company identification and related contacts, Department identification and related contacts, default department Industry and Terminology identifiers, and Document Metadata 160 such as Document identification, document storage pointers, editing metrics (size, grammar errors, spelling errors, word count, and page count.), Notes for the editor, Document lifecycle events such as Customer upload, Waiting for Edit, Checked-out for editing, Checked-out for QA, Ready for pickup, Document Priority and Customer Pickup target date, Document service levels including Priority, Critique, Courier Edit, Efficiency Edit, Diplomat Edit, Machine-Translated Edit, Document routing, Document Quoting and Document tracking.

The Harvest Database contains editing patterns that can be promoted to editing rules in the Dynamic Editing Knowledge Base (DEK) 130. The patterns that may eventually become rules can originate from an Editor who suggests a potential new editing rule or from the Comparison Object 100 which captures the before and after editing from Pre-Edit State Documents 50 and Post-Edit State Documents 90 or finally the potential rules can come from the Promotion Object 110 which is continually harvesting new editing patterns by comparing before and after editing changes which have been applied over time as it examines Pre-Edit State Documents 50 and Post-Edit State Documents 90 that reside in the archives.

The Dynamic Editing Knowledge Base (DEK) 130 contains promoted editing rules that will be applied to documents on their first editing pass in the Job lifecycle. The rules will have identifiers that will determine when it is applicable to apply them which include but are not limited to Industry, Company, Department, Customer, Terminology, Originating language of the document, Target language of the document, language of Document Author and service level requested by customer. These rules will evolve over time as the system learns which rules to apply based on Document identifiers described above.

It will be obvious to those having skill in the art that many changes may be made to the details of the above-described embodiment of this invention without departing from the underlying principles thereof. The scope of the present invention should, therefore, be determined only by the following claims.

1. A process for machine editing of a machine-readable document, the document including text translated from a first natural language into a second natural language, and the process comprising the steps of:
providing an editing knowledge base;
providing a machine-editing software object, coupled to the editing knowledge base, for machine-editing a document;
receiving a document in a machine-readable, pre-machine edit state;
machine-editing the received document using the machine-editing software object so as to produce a post-machine edit state of the document;
manually editing the post-machine edit state of the document, including making a change to the post-machine edit state of the document;
recording the changes to the post-machine edit states of multiple documents;
repeating said receiving, machine-editing, manually editing and recording steps over multiple documents;
analyzing the recorded changes over said multiple documents so as to detect a pattern of such changes; and
refining the editing knowledge base responsive to the detected pattern so as to improve the quality of subsequent machine editing that uses the knowledge base to automatically edit a document.

2. A process according to claim 1 wherein the first language is the same as the second language, and thus the process is used to improve the quality of an original document.

3. A process according to claim 1 wherein said refining the editing knowledge base includes modifying an existing editing rule.

4. A process according to claim 1 wherein said refining the editing knowledge base includes modifying metadata associated with an existing rule.

5. A process according to claim 1 wherein said refining the editing knowledge base includes forming a new editing rule that implements the detected pattern of editing changes and adding the new editing rule to the editing knowledge base.

6. A process for building a dynamic editing knowledge base to support machine editing comprising:
providing an initial set of editing rules;
applying the initial set of editing rules to a series of documents to form machine-edited documents;
checking the machine-edited documents so as to detect any erroneous or inappropriate application of the initial set of editing rules; and
updating the initial set of editing rules in response any such detected errors, thereby improving upon the initial set of editing rules over time.

7. A process according to claim 6 wherein the initial set of editing rules are associated with a selected company.

8. A process according to claim 7 wherein the initial set of editing rules are associated with a particular department within the selected company.

9. A process according to claim 8 wherein the initial set of editing rules are associated with a particular type of document produced by the said department within the selected company.

10. A process according to claim 7 wherein the initial set of editing rules are associated with an individual author within the selected company.

11. An editing rule database comprising a plurality of records, each record comprising:
a first tag identifying a document source as to which the corresponding rule is applicable;
a second tag identifying or defining the editing rule itself; and
a third tag storing experience data with respect to the corresponding rule, to be used in assessing utility of the rule.

12. An editing database according to claim 11 wherein the first tag identifies an industry as the document source for applying the corresponding rule to edit documents created in the context of the identified industry.

13. An editing database according to claim 11 wherein the first tag identifies a company as the document source for applying the corresponding rule to edit documents created in the context of the identified company.

14. An editing database according to claim 13 wherein the first tag identifies a specific department within an identified company as the document source for applying the corresponding rule to edit documents created in the specified department.

15. An editing database according to claim 11 wherein the first tag identifies an individual author as the document source for applying the corresponding rule to edit documents created by the identified author.

16. An editing database according to claim 11 wherein the experience data indicates a number of times the corresponding rule has been applied.

17. An editing database according to claim 11 wherein the experience data indicates a number of times the corresponding rule has been invoked to edit a document correctly.

18. An editing database according to claim 11 wherein the experience data indicates a number of times the corresponding rule has been invoked to edit a document incorrectly.

19. An editing database according to claim 11 wherein the editing rule includes a rule detection object for detecting a possible violation of the rule in a document; and a rule correction object for applying the rule to correct a detected violation.
